(19) United States
(12) Patent Application Publication
(10) Pub. No.: US 2005/0126396 A1
(43) Pub. Date: Jun. 16, 2005

(54) Fine dust removing apparatus for vacuum cleaner

(75) Inventor: Tae-Sang Park, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/005,414

(22) Filed: Dec. 6, 2004

(30) Foreign Application Priority Data
Dec. 10, 2003 (KR) 89873/2003

(51) Int. Cl. B01D 47/00

(52) U.S. Cl. 96/313

(57) ABSTRACT

Disclosed is a fine dust removing apparatus for a vacuum cleaner using a cyclone adapted to supply liquid droplets so that fine dust, which is drawn into the cyclone of the vacuum cleaner, can adhere to the liquid droplets. The apparatus includes a liquid droplet supply pipe connected to the cyclone and a liquid droplet spraying apparatus connected to the liquid droplet supply pipe to supply the cyclone with liquid droplets to which fine dust is attached.

### PRIORITY

This application claims priority to an application entitled “Fine Dust Removing Apparatus For Vacuum Cleaner” filed with the Korean Intellectual Property Office on Dec. 10, 2003 and assigned Serial No. 2003-89873, the contents of which are hereby incorporated by reference.

### BACKGROUND OF THE INVENTION

1. Field of the Invention

The present invention relates to a fine dust removing apparatus for a vacuum cleaner using a cyclone, the apparatus being adapted to supply liquid droplets so that fine dust, which is drawn into the cyclone of the vacuum cleaner, can adhere to the liquid droplets.

2. Description of the Related Art

Various kinds of canister-type vacuum cleaners using the principle of a cyclone are generally known in the art and a typical embodiment thereof will now be described with reference to the accompanying drawings.

As show in FIGS. 1 to 5, a cyclone vacuum cleaner has a body 1, the interior of which is divided into a cyclone mounting compartment 3 and a motor mounting compartment 4 by an intermediate partition 2.

The cyclone mounting compartment 3 has a cyclone 5 having a conventional structure positioned therein to separate and collect contaminants from air drawn in. The motor mounting compartment 4 has a driving motor 6 retained therein to provide a drawing force.

The cyclone 5 includes a cylindrical body 8; a cone portion 7 positioned on the lower portion of the cylindrical body 8; an air drawing connection pipe 9 fixedly connected to the outer peripheral edge of the cylindrical body 8 to guide the drawn air and contaminants in such a manner that they are drawn along the tangential direction; an air discharge pipe 10 positioned on the middle portion of the upper surface of the cylindrical body 8 to discharge air; and a hopper 11 fixedly coupled to the lower portion of the cone portion 7 to collect contaminants.

The hopper 11 has a male screw portion 12 formed on the outer peripheral surface thereof and a cap 13 coupled to the lower surface thereof in such a manner that it can be released when disposing of the contaminants.

The hopper 11 has a cylindrical shape in order to prevent contaminants, which are separated from the drawn air, from rebounding and being discharged to the air discharge pipe 10.

The cyclone mounting compartment 3 has a fixation plate 15 positioned on the bottom surface thereof. The fixation plate 15 has a screw portion 14 formed on the internal wall thereof so that the hopper 11 of the cyclone 5 can be fixedly screw-coupled thereto.

In the drawings, reference numeral 16 refers to a motor protection filter; 17 a fine dust removing filter; 18 and 19 are wheels; 20 is a seal; and 21 a connection pipe.

The canister-type vacuum cleaner using the principle of a conventional cyclone, as mentioned above, is operated as follows: if power is supplied to the driving motor 6 for cleaning work, contaminants are drawn into the body 1 together with drawn air A1 via a drawing opening (not shown) which is connected to the body 1 by the connection pipe 21.

After being drawn into the body 1, the drawn air A1 and the contaminants pass through the air drawing connection pipe 9 of the cyclone 5 mounted in the cyclone mounting compartment 3 of the body 1 and travel in the tangential direction along the inner peripheral wall of the cylindrical body 8.

After being drawn into the cyclone 5 via the air drawing connection pipe 9 of the cyclone 5, the drawn air A1 and the contaminants descend helically along the inner peripheral wall of the cone portion 7, as shown in FIGS. 4 and 5, when they are rotated in the tangential direction along the inner peripheral wall of the cylindrical body.

As the inner diameter of the cone portion decreases, the velocity of the drawn stream made up of the drawn air A1 and the contaminants increases gradually according to the principle of rotational moment.

The drawn air A1 and the contaminants are subject to different centrifugal forces due to their differences in density. The heavier contaminants descend along the inner peripheral wall of the cone portion 7 and are collected by the hopper 11. The drawn air A1, in contrast, changes direction at the bottom of the cone portion 7 and begins to ascend. The drawn air A1 is rotated with a smaller radius while ascending and is discharged out of the cyclone via the air discharge pipe 10. After being subject to such a primary purification, the drawn air A1 is discharged out of the body 1 via the motor protection filter 16 and the fine dust removing filter 17 by means of the continuous driving of the driving motor 6.

When a large amount of contaminants are collected in the hopper 11 of the cyclone 5, which is screw-coupled to the fixation plate 15, the hopper 11 is separated from the fixation plate 15 and the cap 13 is separated from the lower portion of the hopper 11 to dispose of the contaminants.

Conventional cyclone cleaners separate and remove fine dust from drawn air A1 by a centrifugal force. The force acting on the dust includes a centrifugal force and a drag force caused by the flow of the air A1. The drag force may also be referred to as a resistant force of fluid.

Although dust can be easily separated when the centrifugal force is larger than the drag force, dust is not separated but is entrained by the flow of air A1 in the opposite case. The centrifugal force is proportional to the cube of the diameter of the dust, while the drag force to the square thereof. Accordingly, the smaller the diameter is, the more the centrifugal force decreases as compared to the drag force, and the more difficult the separation becomes. As a result, conventional cyclone cleaners have a problem in that they must be separately equipped with a fine dust removing paper filter in order to separate fine dust and the filter must be replaced periodically.

U.S. Pat. No. 6,623,539 (the contents of which are hereby incorporated by reference) discloses a cyclone cleaner including a cyclone dust collecting apparatus; an air drawing pipe; an air inlet formed on the air drawing pipe; and a guide for causing air to flow into the air inlet. However, the guide is merely adapted to guide the flow of air in an efficient manner and the cleaner still has the problem of having to be separately equipped with a fine dust removing filter in order to separate fine dust.

### SUMMARY OF THE INVENTION

Accordingly, the present invention has been made to solve the above-mentioned problems occurring in the prior art, and an object of the present invention is to provide a fine dust removing apparatus for a vacuum cleaner using a cyclone, the apparatus being adapted to supply liquid droplets so that fine dust particles, which are drawn into the cyclone of the vacuum cleaner, can adhere to the liquid droplets and can be removed with improved efficiency.

Another object of the present invention is to provide a fine dust removing apparatus for a vacuum cleaner using a cyclone, the apparatus being adapted to supply liquid droplets so that fine dust particles, which are drawn into the cyclone of the vacuum cleaner, can adhere to the liquid droplets without any need for a fine dust removing filter, thus substantially eliminating any inconvenience resulting from the periodic replacement of the filter.

In order to accomplish this object, there is provided a fine dust removing apparatus for a vacuum cleaner using a cyclone, the apparatus including a liquid droplet supplying pipe connected to the cyclone, and a liquid droplet spraying apparatus connected to the liquid droplet supplying pipe to supply the cyclone with liquid droplets to which fine dust particles become attached.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional top view showing the construction of a vacuum cleaner using the principle of a cyclone according to the prior art;

FIG. 2 is a sectional side view showing the construction of a cleaner using the principle of a cyclone according to the prior art;

FIG. 3 is a top view illustrating the principle of a cyclone according to the prior art;

FIG. 4 is a front view illustrating the principle of a cyclone according to the prior art;

FIG. 5 is a perspective view showing a cyclone according to the prior art;

FIG. 6 is a perspective view showing the construction of a fine dust removing apparatus for a vacuum cleaner according to the present invention;

FIG. 7 is a sectional side view showing the movement of fine dust as the fine dust removing apparatus for a vacuum cleaner according to the present invention is operated;

FIG. 8 is a side sectional view showing the attachment of fine dust to liquid droplets created by the fine dust removing apparatus for a vacuum cleaner according to the present invention; and

FIG. 9 is a top view showing the principle of a cyclone for removing fine dust which attaches to liquid droplets created by the fine dust removing apparatus for a vacuum cleaner according to the present invention.

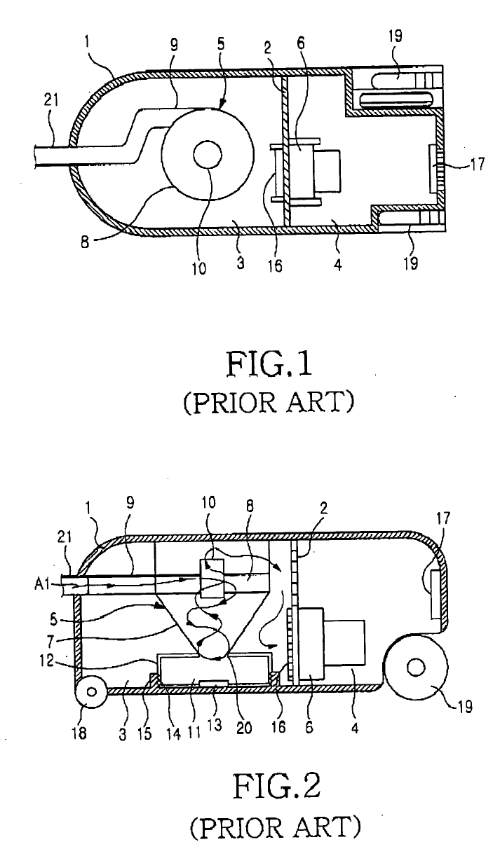

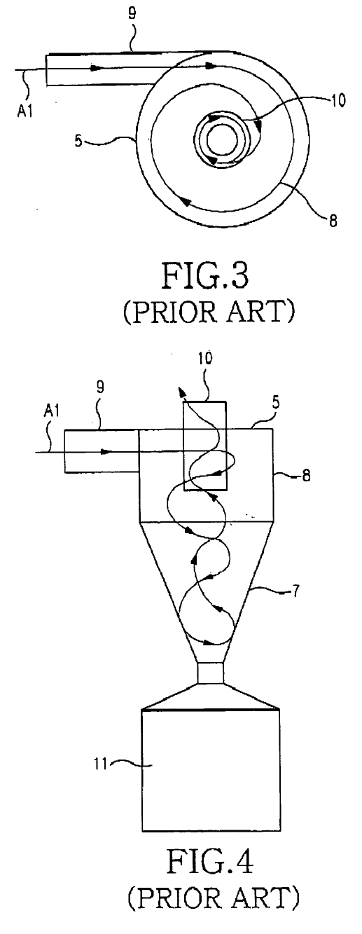

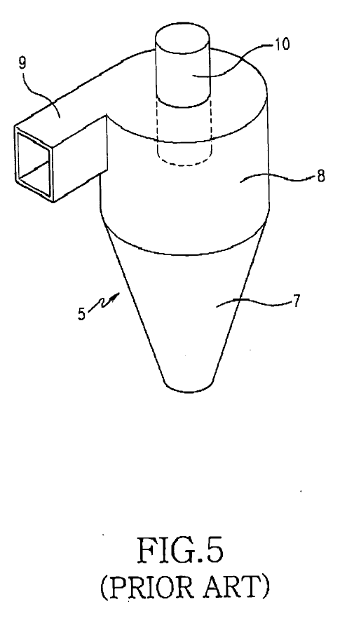

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configurations incorporated herein will be omitted when it may make the subject matter of the present invention unclear.

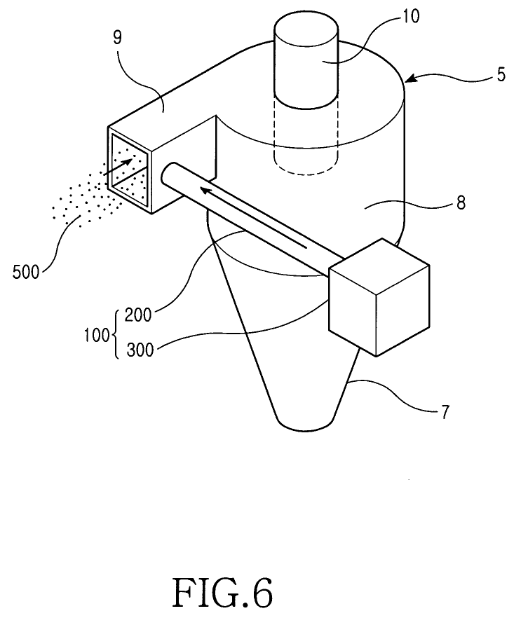

As shown in FIGS. 6 to 9, a fine dust removing apparatus 100 for a vacuum cleaner includes a liquid droplet supply pipe 200 and a liquid droplet spraying apparatus 300.

The liquid droplet supply pipe 200 is connected to a cyclone 5 so that liquid droplets 400 supplied from the liquid droplet spraying apparatus 300 can reach the cyclone 5.

The liquid droplet spraying apparatus 300 is connected to the liquid droplet supply pipe 200 so that the cyclone 5 can be supplied with liquid droplets 400, to which fine dust particles 500 become attached, via the liquid droplet supply pipe 200.

The liquid droplets 400 have a shape larger than that of the fine dust particles 500 so that fine dust particles 500, upon being drawn into the cyclone 5, can be attached around the surface of the liquid droplets 400.

The liquid droplet supply pipe 200 has an end connected to an air drawing connection pipe 9 formed on the cyclone 5 and the other end connected to the liquid droplet spraying apparatus 300.

While having fine dust particles 500 attached to the surface thereof, the liquid droplets 400 are separated from the stream of air A1 by the centrifugal force of the cyclone 5.

The operation of the fine dust removing apparatus for a vacuum cleaner according to a preferred embodiment of the present invention, configured as above, will now be described with reference to FIGS. 6 to 9.

As shown in FIG. 6, the fine dust removing apparatus 100 for a vacuum cleaner includes a liquid droplet supply pipe 200 and a liquid droplet spraying apparatus 300.

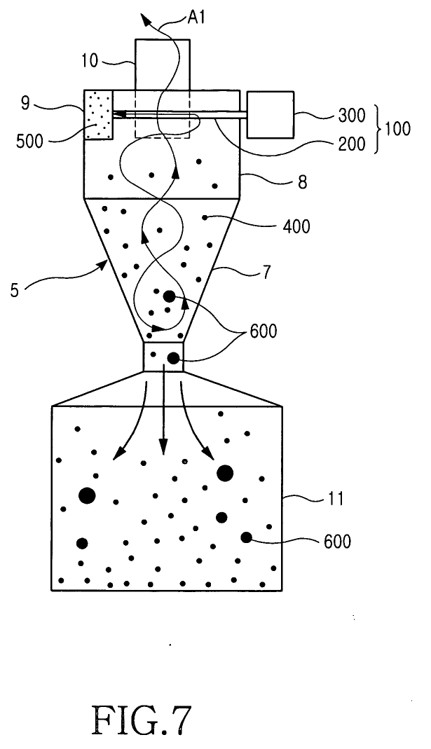

Fine dust particles 500 are drawn into the cyclone 5 of the vacuum cleaner as shown in FIG. 7.

When the fine dust particles 500 are drawn into the air drawing connection pipe 9 formed on the cyclone 5, the liquid droplet spraying apparatus 300 supplies liquid droplets 400, to which the fine dust particles 500 attach, into the air drawing connection pipe 9 via the liquid droplet supply pipe 200.

The liquid droplet supply pipe 200 has an end connected to the air drawing connection pipe 9 and the other end connected to the liquid droplet spraying apparatus 300.

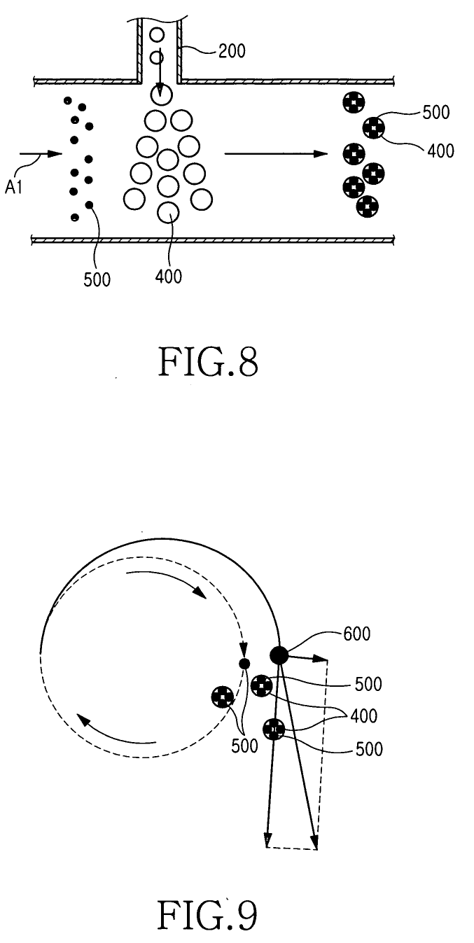

After being drawn into the air drawing connection pipe 9, the fine dust particles 500 pass through the connection pipe 9 as shown in FIG. 8 and attach to the surface of the liquid droplets 400, which are supplied into the air drawing connection pipe 9.

The liquid droplets 400 have a shape larger than that of the fine dust particles 500 so that the fine dust particles 500, which are drawn via the air drawing connection pipe 9, attach around the surface thereof.

While coarse dust particles 600 are rotated together with the rotating air A1 and are separated from the flow path by way of the centrifugal force, as shown in FIG. 9, fine dust particles 500 follow the flow path because they are subjected to a smaller centrifugal force. Upon attaching to the surface of liquid droplets 400, the fine dust particles 500 are separated and removed from the stream of air A1 together with the liquid droplets 400, because the fine dust particles 500 are then subjected to a larger centrifugal force than the coarse dust particles 600, together with the liquid droplets 400.

After being separated, the fine dust particles 500 and the liquid droplets 400 descend toward the lower portion of the cyclone 5 and are collected into the hopper 11 positioned thereon.

As mentioned above, the fine dust removing apparatus for a vacuum cleaner according to the present invention supplies liquid droplets so that fine dust, which is drawn into the cyclone, can attach thereto. Therefore, the vacuum cleaner can remove fine dust with an improved efficiency and dispense with the need for a fine dust removing filter. This avoids the inconvenience of having to replace the filter periodically and improves the service of the vacuum cleaner.

While the invention has been shown and described with reference to certain preferred embodiments thereof, it will be understood by those skilled in the art that various changes in form and details may be made therein without departing from the spirit and scope of the invention as defined by the appended claims.

1. A fine dust removing apparatus for a vacuum cleaner using a cyclone, the apparatus comprising:
a liquid droplet supply pipe connected to the cyclone; and
a liquid droplet spraying apparatus connected to the liquid droplet supply pipe to supply the cyclone with liquid droplets to which fine dust particles attach.

2. A fine dust removing apparatus for a vacuum cleaner as claimed in claim 1, wherein the liquid droplets have a shape larger than that of the fine dust particles, so that the fine dust particles, upon being drawn into the cyclone, attach to the surface of the liquid droplets.

3. A fine dust removing apparatus for a vacuum cleaner as claimed in claim 1, wherein the liquid droplet supply pipe has an end connected to an air drawing connection pipe formed on the cyclone, and the other end connected to the liquid droplet spraying apparatus.

4. A fine dust removing apparatus for a vacuum cleaner as claimed in claim 1, wherein the liquid droplets and fine dust particles are separated from an air stream by a centrifugal force created by the cyclone.

5. A method of removing fine dust from a drawn air stream, comprising the steps of:
providing a stream of liquid droplets to mix with the drawn air, whereby fine dust particles in the air stream adhere to the liquid droplets; and
providing a centrifugal force upon the stream of mixed fine dust particles and liquid droplets, whereby the centrifugal force separates the mixture of liquid droplets and fine dust particles from the drawn air.
